(19) United States
(12) Patent Application Publication
(10) Pub. No.: US 2014/0222560 A1
(43) Pub. Date: Aug. 7, 2014

(54) SYSTEM AND METHOD FOR MONETIZATION IN PHOTO SHARING SITES

(71) Applicant: YAHOO! INC., Sunnyvale, CA (US)

(72) Inventor: Nagaraj Kota, Bangalore Karnataka (IN)

(73) Assignee: YAHOO! INC., Sunnyvale, CA (US)

(21) Appl. No.: 13/758,500

(22) Filed: Feb. 4, 2013

(51) Int. Cl. G06Q 30/02

(52) U.S. Cl. CPC G06Q 30/0255
USPC 705/14.53

(57) ABSTRACT

Disclosed is a system and method for selecting and serving advertisements in response to requests for photos on a photo-sharing website. In some embodiments, the present disclosure describes a system and method for automatically matching an advertisement with a media file when the media file has been rendered by a user. Aspects of the present disclosure allow for automatic selection and serving of advertisements based on a requested media file and/or user profile information, potentially without any interaction between the user and the advertiser.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to a selecting advertisements, and more specifically to a system and method for monetizing photo-sharing sites by serving advertisements based upon content currently being rendered in view of a user's activities or expressed interests.

### RELATED ART

The expansion of the Internet and the World Wide Web (“web”) has given computer users the enhanced ability to view, listen and watch various forms of media through their computers. This media can be in the form of images, audio, text and/or video. Advertising through the use of the Internet and the web has become increasingly popular as a way to promote products and services to consumers. Use of the Internet to advertise products and services often takes the form of banner advertisements, pop-up advertisements, interstitials, frame advertisements, and the like.

### SUMMARY

Advertisers typically strive to display advertising to relevant audiences by targeting specific advertising content to specific contexts. One example of a targeted context is audience gender. For instance, advertisers often prefer to serve advertisements for goods or services of interest to men on web pages more commonly viewed by men (e.g., www.espn.com). Other examples of targeted contexts include audience age, income, location and education. In order to target advertising content to a desired context, advertisers often perform extensive and expensive research.

The present disclosure addresses failings in the art by providing a system and method for displaying contextually relevant advertisements to users as media objects are being rendered. That is, advertisements are automatically matched with a media file when the media file has been requested by a user (or consumer). The display of the advertisements is based upon the content being rendered. Additionally, the displayed advertisements are also based in part up on a user's profile information, which includes data representing the user's activities and interests. Serving advertisements in this manner reduces costs, increases click-through rates (CTR), increases revenue or return on investment (ROI), and increases efficiency. As will be understood from the present disclosure, as the subject matter of the media objects being viewed (or rendered) changes, different advertisements related to new contexts can be provided that replace the prior advertisement(s).

Preferred embodiments of the present disclosure relate to serving advertisements upon a user visiting photo-sharing sites, such as Flickr®, Instagram, or other social networking sites, or viewing content (e.g., images) on such sites. Photo-sharing sites (or image/video hosting services) are web sites which enable online content management and sharing capabilities. Such sites generally cover many more user interests than other typical news or media sites. For example, user A is viewing images from a friend's recent visit to a homestay or a food chain in local neighborhood. The systems and methods discussed herein can be used to display product/homestay ads, or local business listings or deals related to the image content user A is viewing. It should be understood that photo-sharing sites are not limited to managing and sharing photos, as other types of content, e.g., videos, can be hosted and shared on such sites.

Conventionally, photo-sharing sites perform a very broad match of ads to users. This typically results in advertisements which are less relevant to user context and their interests. The present disclosure's disclosed systems and methods personalize advertisement content to a user based on a user's data, which can include the content they are currently viewing, and their predisposed expressed interests and activities. It should be understood that the application of the systems and methods discussed herein are not solely applicable to photo-sharing sites, as the functionality discussed herein can be applied to all types of web pages and content a user can view over the Internet or web, either through a personal computer or mobile device.

In accordance with one or more embodiments, a method is disclosed which includes receiving, at a computing device over a network, a request from a user for a photo on a page of a photo-sharing website; identifying, via the computing device, descriptive information related to said photo; searching, via the computing device, a user profile associated with the user for segment information comprising segment data and segment metadata, said segment data comprising a prioritized listing of content categories representative of a level of interest the user has for each content category, said segment metadata comprising descriptive information related to each category, said searching comprising identifying a specific content category among the segment data based on the descriptive information of the photo; searching, via the computing device, an advertisement database to identify an advertisement based on the identified content category; and facilitating serving, via the computing device, said advertisement with said photo on the page to the user over the network.

In accordance with one or more embodiments, a non-transitory computer-readable storage medium is provided, the computer-readable storage medium tangibly storing thereon, or having tangibly encoded thereon, computer readable instructions that when executed cause at least one processor to perform a method for monetizing photo-sharing sites by serving advertisements based upon content currently being rendered in view of a user's activities or expressed interests.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating a client device in accordance with some embodiments of the present disclosure;

FIG. 3 is flowchart illustrating steps performed in accordance with an embodiment of the present disclosure; and

FIG. 4 is a block diagram of a web server communicating with a user database and advertisement server over a network in accordance with an embodiment of the present disclosure;

FIG. 5 is a flowchart illustrating steps performed in accordance with an embodiment of the present disclosure;

FIG. 6 is a flowchart illustrating steps performed in accordance with an embodiment of the present disclosure;

FIG. 7 is a flowchart illustrating steps performed in accordance with an embodiment of the present disclosure;

FIG. 8 illustrates an advertising serving engine in accordance with an embodiment of the present disclosure; and

FIG. 9 is a block diagram illustrating architecture of a hardware device in accordance with one or more embodiments of the present disclosure.

### DESCRIPTION OF EMBODIMENTS

The present disclosure will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, Flickr®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

The principles described herein may be embodied in many different forms. Generally, the described systems and methods allow advertisements to be provided or served on webpages or web sites via a network, such as the Internet. In some exemplary embodiments, advertisements are provided to a user upon the user viewing content, e.g., photos, videos, and the like, on photo-sharing sites. In some embodiments, such contextually related advertisements are also served to the user during the user's traversal of other web pages within the photo-sharing site. Advertisements can be content related, search related, images, videos, motion graphics, banner ads or display ads, in static or media rich formats. Advertisements can be either skippable or un-skippable, which is determined by the advertiser or publisher of the content. For non-video content, ads can be placed adjacent to the content. For video content, advertisements can be overlaid on top of existing content. An advertiser pays for their advertisement to be present in front of users. Thus, the present disclosure ensures that the presented advertisements are contextually related to the content and the user specific information which leads to increased ROI (Return on Investment) and CTR (Click-through Rate), among other understood incentives. Additionally, this can enable fewer advertisements being served (which reduces overall costs) while increasing revenues and avoiding advertisement abandonment.

According to preferred embodiments, the present disclosure will be described with reference to monetization techniques for advertising within the scope of users visiting, viewing, uploading, downloading, sharing, and the like, content within photo sharing sites (or social network sites), e.g., Flickr®. It should be understood that while the present disclosure is discussed with reference to photo sharing sites, e.g., Flickr®, additional embodiments exist and are within the scope of the methods and systems discussed herein involving other types of web sites and pages, e.g., news, business, sports, education, leisure, art, and the like. The present disclosure describes methods and systems for understanding user interests and behavior respective of such sites and utilizing such information to personalize advertisements and content available on those sites/pages. The present disclosure leverages data derived from content served on sites, e.g., Flickr®, and user specific information, e.g., user interests, for monetary purposes.

As discussed in more detail below, user specific information (or user profile information) can be stored within a user profile for each user and can include data representing a user's interests and activities (either based on their current viewing activities or patterns, or historically based on such information). Such information can be based upon a user's expressed interests, a user's location, and/or a user's historical or current behavior. This information, in addition to other user profile information generally understood by those of skill in the art (e.g., name, age, gender, address, email address, and the like), can be compiled to form segment information for a user, as discussed below. As an example, by tracking a user's path through a web site or network of sites, and compiling a profile based at least in part on pages or content a user renders or views, information can be collected indicating content, or types of content a user is interested in.

A user's interests in a particular type of content can be based upon certain metrics (or scores), including, but not limited to, whether the user likes or dislikes the content (e.g., ratings or rankings the users applies to the context from a social aspect), time spent on the content, frequency the user visits the content or related content, the type of content the user recently visited, the click-through rate (CTR) of the content, and in instances of sets of content, the number of, e.g., images viewed amongst the set. In some embodiments, in addition to such interests being dynamically collected, a user's interests can be pre-defined by the user, or based in part upon the user's location and/or demographics. For example, a user's interests can include locations for which the user has expressed interest, such as, for example, locations where the user vacations, owns property, has family, etc. A user's interests can be predefined by the user, based upon the user's viewing or rendering activity (past, present or projected), or input in real-time during a search request. Indeed, the user's interests can also be dynamically compiled based on the user's search history, or viewing history. For example, if a user has frequently (or recently) viewed another user's Flickr® photo album, then the content in the photo album, and/or that other user, can be identified and utilized within an interest segment for the viewing user.

Thus, the present disclosure leverages the identified user interests into creating specific segments (or segment information) for users. Segments can be determined by analyzing information including content and/or metadata associated with the content a user interacts with, and categorizing such information associated with such content, e.g., based on the type of content. Segment information can also be compiled respective of other user's profile information collected respective of similar sites/pages. For example, if a user views content, such as images and text, related to sports, news and leisure, segments can be created within the user's profile for the content types: sports, news and leisure. As discussed below, if the user has expressed interests through his/her network activity showing a greater interests in sports than the news and leisure, the segment information for sports can be ranked higher respectively within the user's profile.

In exemplary embodiments, the information utilized to compile segments can be derived from the content or data a user creates; content or information a user renders; features around images that a user uploads/downloads; descriptions, tags, comments and image features including geo-data and exchangeable image file format (exif) data related to the content. Additionally, segments can be determined based upon the features related to images that a user views; social circles (including social-graph data); search session, image categorical data, and the like. Indeed, segments can be determined based in part upon user profile information across network platforms, e.g., Yahoo!® network, including search, finance, sports, music content, and the like. Thus, segments or segment information (which includes segment data and associated segment metadata) include information that specifies the types and formats for images, sound, video, and ancillary metadata (or tags) associated with the content the user renders and the users themselves. Such metadata can include, but is not limited to, digital data including type, format, data and time information, description information, source information, copyright information, geo-location information, compression data, security information, and the like. This information can be contingent upon the device(s), users or platforms used to create, view or upload the content.

Based on the above information, segments can be determined to include, but are not limited to, specific (or categorized) content sets. For example, segment information can be related to concert shows, travel, life events, and the like. For example, travel segments can include multiple sub-segments depending on the travel concepts: city, beach, snow/ski, road trips, region, and the like. Life events can also include multiple sub-segments: marriage, baby pictures, graduation, and the like. Thus, the present disclosure can employ categorizers using logistic regression or learning models including support vector machines (SVMs) to map these segments into predefined nodes in a business taxonomy, which are then utilized in behavior targeting by advertisers. It should be understood that known or to be known learning algorithms and models that analyze data and recognize patterns for classification and regression analysis can be utilized in accordance with the present disclosure. As discussed below, users can be associated with specific segments, and served advertisements based upon their associated segments. It should be understood that the examples of segments listed above are non-exhaustive, and the possibility of segments having multiple sub-segments, and sub-segments having multiple sub-segments is included within the scope of the present disclosure.

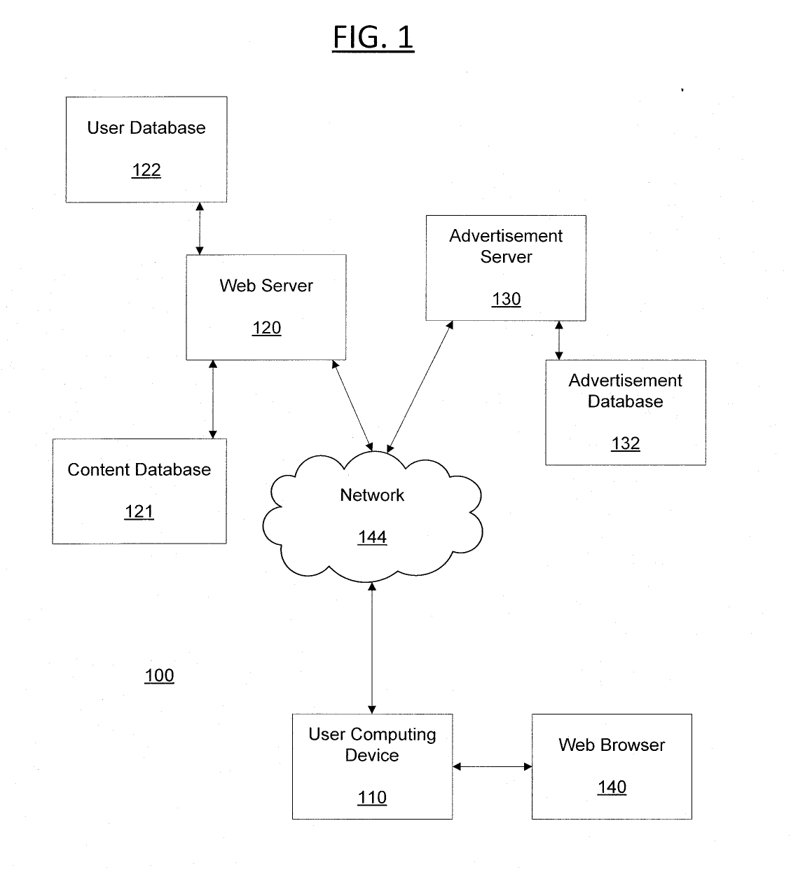

As discussed in more detail below with reference to FIGS. 1-9, the present disclosure describes systems and methods for selecting and serving advertisements based on the current context (search results or page content) and the user segments. As discussed herein, the segments can be derived from user profile information, included in user profile information, or derived from a user's input (e.g., search request). The segments identify user specific and defined interests. As such, in order to determine which advertisements are relevant to a user, the advertisements served by an advertisement server containing ad metadata. The ad metadata is correlated with segments affiliated with a user and the context of the content a user is viewing (or requesting). Thus, as discussed below with reference to the Figures, advertisements are matched to users based at least upon segments associated with each user. When the advertising server is presented with a segment, the ad server compiles the segment information, in conjunction with the information being served on a content page, and determines if there is a match. Upon a match being identified, the advertisement associated with the ad metadata is served to the user along with the content page.

In a non-limiting example illustrating the overall scope of the present disclosure, a female user in Sunnyvale, Calif. has recently uploaded pictures on her Flickr® account of her favorite pet dog “Bruno.” Thus, her Flickr® page (or album) has content related to pets. As a result, pet product ads, such as pet food, pet shampoo or pet clothes may be displayed on the web pages within the Flickr® site where the pictures of Bruno appear. Additionally, when another user located in Sunnyvale, Calif. views the images of Bruno, pet products/services advertisements can be displayed. These ads may serve to attract the new customers to local retailers. That is, the advertisements may include information for pet stores or services for pets in Sunnyvale, Calif.

In another non-limiting example with respect to a social media context, on user A's social media page, he/she has uploaded a picture of his/her new born baby. The latest activity related to user A's social page corresponds to the baby. Therefore, for users viewing the user's social page, advertisements for baby products can be displayed in accordance with the user's social page. Indeed, if user B located in Austin, Tex. is viewing the pictures of a baby, advertisements related to baby products/services available in Austin, Tex. can be displayed. Additionally, as user A subsequently posts pictures of the new born growing up, advertisements being served on such pages can adaptively adjust to the content of the pictures posted on the site (e.g., ads related to the age of the child). That is, custom ads from advertisers can be served based on, e.g., the age and/or gender of the child pictured. Accordingly, if another user, user C, is viewing the pictures of the child, and that user is located in New York, N.Y., user C may be served advertisements for local toy chains, e.g., Toys “R” Us® in New York City, which can be derived from segment data (or metadata) associated with user C, and the content of the viewed media.

In yet another non-limiting example, user D is travelling to Hollywood, Calif. While traveling, user D has taken a picture and uploaded/shared the picture via her smartphone. As understood in the art, there is metadata associated with such pictures, such as the geo-location, time, and the like. Thus, such metadata can be leveraged for showing ads related to information corresponding to the picture. For example, advertisements can be served relating to, for example, hotel deals in Hollywood, Calif., universal studios tickets, concert/food events, sponsored listings to reviews sites, and the like. As will be understood from the below description, service of advertisements is not based solely upon the content a user is viewing (or rendering). That is, advertisements can be served based on a user's expressed interests, as discussed above. Such expressed interests are compiled in a user profile for the user as segment information. Therefore, advertisements can be contextually related to the user's expressed interests (or segment information). Thus, from the example above, if user D has previously not expressed interests regarding Hollywood, Calif., or has exhibited greater interests in other topics (e.g., by more recently and/or frequently viewing other content), advertisements can be served to the user based on the other topical content. In some embodiments, advertisements can be based on the contextual content the user is viewing and the user's segment information (expressed interests), while in some embodiments, the content of the advertisements may be solely based upon the user's interests (segment information) or the content being viewed. It should also be understood that the content of the advertisements can be based on the cost for rendering such advertisements, in addition to or irrespective of user interests or rendered content.

Certain embodiments will now be described in greater detail with reference to the figures. In general, with reference to FIG. 1, a system 100 in accordance with an embodiment for providing a personalized advertisement is shown. The user can access content from a user computing device 110. The content may be provided by web server 120 over network 144. Thus, in order to provide the content, the web server 120 may be associated with a content database 121 (or repository). Content within the content database 121 can include media or multimedia, and such content may be annotated. Examples of content may include text, images, audio, video, or the like, which may be processed in the form of physical signals, such as electrical signals, for example, or may be stored in memory, as physical states, for example. Content may be contained within an object, such as a Web object, Web page, Web site, electronic document, or the like. An item in a collection of content may be referred to as an “item of content” or a “content item,” and may be retrieved from a “Web of Objects” comprising objects made up of a variety of types of content. The term “annotation,” as used herein, refers to descriptive or contextual content related to a content item, for example, collected from an individual, such as a user, and stored in association with the individual or the content item. Annotations may include various fields of descriptive content, such as a rating of a document, a list of keywords identifying topics of a document, and the like.

Thus, it should be understood that the web server 120 can be referred to as a “content server.” A content server may include a device that includes a configuration to provide content via a network to another device. A content server may, for example, host a site, such as a social networking site, examples of which may include, without limitation, Flickr®, Twitter®, Facebook®, LinkedIn®, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, and the like.

According to some embodiments, the present disclosure may also be utilized within a social network. A social network refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks.

In some embodiments, multi-modal communications may occur between members of the social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, set-top boxes, SMS/MMS, email, instant messenger clients, forums, social networking sites, or the like.

An advertisement may be served to user computing device 110 from advertisement server 130 over the network 144. Each of user computing device 110, web server 120 and advertisement server 130 can be communicatively coupled via the network 144, such as the Internet. Although different steps are being performed by the web server 120 and the advertisement server 130, it should be noted that any one or more of the steps can be performed by either of the web server 130 and the advertisement server 130, or the function can be combined in a single server.

In accordance with some embodiments, the ad server 130 and the web server 120 can be a single server or multiple servers, and can be at a single location or multiple locations. Portions of advertisement content and advertising metadata may be stored at advertisement database 132. Advertising content and metadata can be accessed by and served from advertisement server 130 to the user computing device 110 based upon keywords, tags or other information known about each portion of content being transmitted by the web server 120. Additionally, ad content and metadata can be served based on user information, which is stored at user database 122, as is described in further detail below.

The user database 122 may be based upon a profile builder, as understood by those of skill in the art. A profile builder may initiate generation of a profile, such for users of an application, including a search engine, for example. A profile builder may initiate generation of a user profile for use, for example, by a user, as well as by an entity that may have provided the application. For example, a profile builder may enhance relevance determinations and thereby assist in indexing, searching or ranking served advertisements, search results, and the like. Therefore, an ad serving engine, or a search engine provider may employ a profile builder, for example.

A variety of mechanisms may be implemented to generate a profile including, but not limited to, collecting or mining navigation history, stored documents, tags, or annotations, to provide a few examples. A profile builder may store a generated profile. Profiles of users of a search engine, for example, may give a search engine provider a mechanism to retrieve annotations, tags, stored pages, navigation history, or the like, which may be useful for making relevance determinations of search results, such as with respect to a particular user.

An ad server 130 comprises a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user. Such sponsored advertising includes monetization techniques including sponsored search advertising, non-sponsored search advertising, guaranteed and non-guaranteed delivery advertising, ad networks/exchanges, ad targeting, ad serving and ad analytics.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers. For web portals like Yahoo!®, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s). Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

User computing device 110 includes a web browser 140, or other program for interfacing with the network. The web server 120 provides content, e.g., Web pages, which are accessible by the user computing device 110. One of the Web pages includes reference to the advertisement. Such an advertisement, which may contain portions written in HTML, XML, Macromedia Flash, Java, JavaScript, and the like, is served by advertisement server 130, as is generally known in the art.

It is to be understood that the present disclosure may be implemented utilizing any number of computer technologies. For example, although certain embodiments relate to providing access to content via the Internet, the disclosure may be utilized over any computer network, including, for example, a wide area network, local area network or, corporate intranet. Similarly, the user computing device 110 may be any computing device that may be coupled to the network 144, including, for example, personal computers, game consoles, smart TVs, personal digital assistants, Web-enabled cellular telephones, devices that dial into the network, mobile computers, tablet computers personal computers, Internet appliances, wireless communication devices and the like. Furthermore, the servers described herein may be of any type, running any software, and the software modules, objects or plug-ins may be written in any suitable programming language

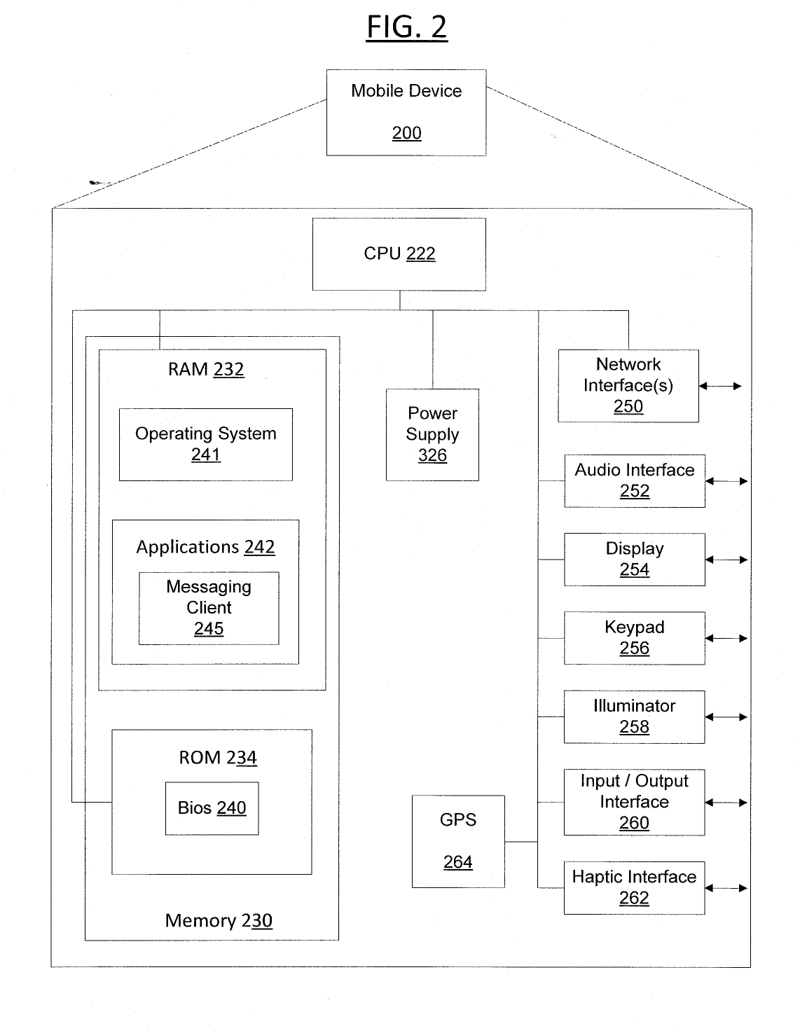

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices 101-104 discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to Client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling Client device 200 to one or more networks, and is constructed for use with one or more communication protocols and technologies including, but not limited to, global system for Client communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when the Client device 200 receives a communication from another user.

Optional GPS transceiver 264 can determine the physical coordinates of Client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. It is understood that under different conditions, GPS transceiver 264 can determine a physical location within millimeters for Client device 200; and in other cases, the determined physical location may be less precise, such as within a meter or significantly greater distances. In one embodiment, however, Client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of Client device 200. The mass memory also stores an operating system 241 for controlling the operation of Client device 200. It will be appreciated that this component may include a general purpose operating system such as a version of UNIX, or LINUX™, or a specialized client communication operating system such as Windows Client™, or the Symbian® operating system. The operating system may include, or interface with a Java virtual machine module that enables control of hardware components and/or operating system operations via Java application programs.

Memory 230 further includes one or more data stores, which can be utilized by Client device 200 to store, among other things, applications 242 and/or other data. For example, data stores may be employed to store information that describes various capabilities of Client device 200. The information may then be provided to another device based on any of a variety of events, including being sent as part of a header during a communication, sent upon request, or the like. At least a portion of the capability information may also be stored on a disk drive or other storage medium (not shown) within Client device 300.

Applications 242 may include computer executable instructions which, when executed by Client device 200, transmit, receive, and/or otherwise process audio, video, images, and enable telecommunication with another user of another client device. Other examples of application programs include calendars, browsers, contact managers, task managers, transcoders, database programs, word processing programs, security applications, spreadsheet programs, games, search programs, and so forth. Applications 242 may further include messaging client 245 that is configured to send, to receive, and/or to otherwise process messages using SMS, MMS, IM, email, VOIP, and/or any of a variety of other messaging communication protocols. Although a single messaging client 245 is illustrated it should be clear that multiple messaging clients may be employed. For example, one messaging client may be configured to manage SMS messages, where another messaging client manages IM messages, and yet another messaging client is configured to manage serving advertisements, emails, or the like.

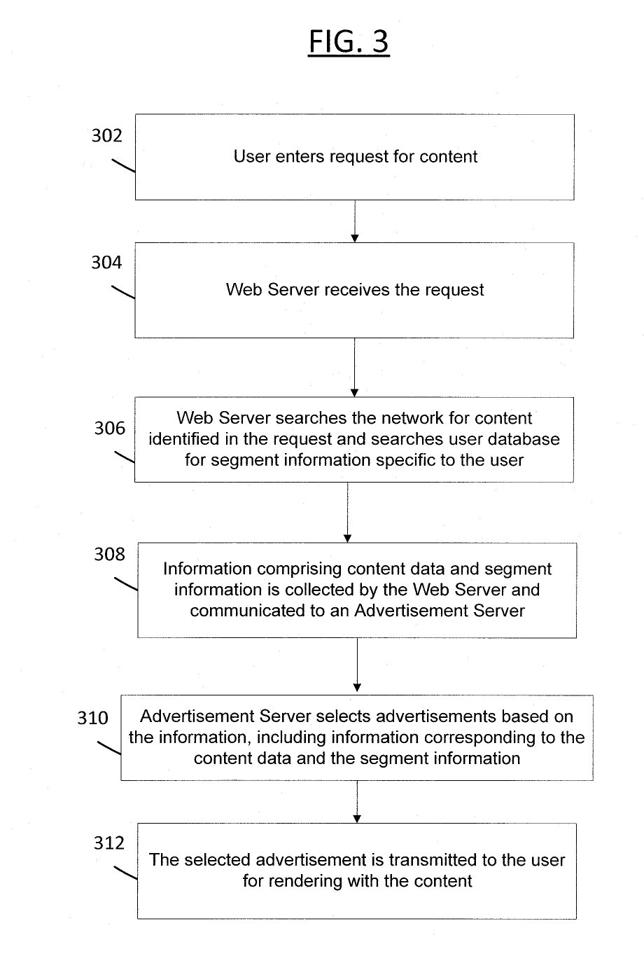

Having described the components of the general architecture employed within the disclosed systems and methods, the components general operation with respect to the disclosed systems and methods will now be described with reference to FIG. 3. FIG. 3 is a flowchart illustrated steps for serving advertisements to a user viewing a content page on his/her computing device. The ads can be served in accordance with content the user is viewing or rendering. In some embodiments, the ads can be additionally, or alternatively, related to user profile information related to the user.

In Step 302, a user enters a request for content. In some preferred embodiments, the request for content includes rendering content. Such rendering can include viewing, downloading, uploading, editing, and the like, images, video, text, or audio. For example, a user request can embody a user uploading a picture to his/her Flickr® account, or viewing another user's uploaded picture on Flicker®. In another example, the request can be generated by the user searching for a content page via a search engine, e.g., searching for images on yahoo.com. The request may also be generated by the user entering a URI or URL in the address bar of an Internet browser. Additionally, the request can be generated by the user clicking on a hyperlink of a displayed page. In some embodiments, appended to the user request is identifying information related to the user. Such user information can be utilized by a web server 120 to identify the user and poll a user database 122 for user-specific content stored within the user database 122, e.g., user profile information. Such user information can also be used to update a user's profile information related to the content a user is requesting.

At Step 304, the request for the content page is transmitted to a web server. Upon receipt of the request, the web server performs a search for the requested content page, and polls a user profile of the user within the user database for user profile information matching the content on the content page. Step 306. The request for the content page includes identifying content data respective of the content page. For example, if the content page displays a picture of Yankee Stadium, the user' s profile will be searched for user (profile) information related to baseball. In some embodiments, the search can be performed according to a filter/funnel search, in that the search will be begin with a broad scope, then filter/funnel down upon finding matching content. User profile information includes information respective of the user's activities or interests, or, as discussed above, the user's segment information comprising segment data and associated metadata which is an organized and categorized listing of the user's interests. In preferred embodiments of Step 306, the user profile information the web server identifies and retrieves is segment information. In some embodiments, Step 306 further involves the web server providing information related to the requested content page to the user database. This information can be utilized to update and/or modify a user's profile information, including his/her segment information, to reflect the user's recent activity. According to some embodiments, the web server can search the user database along with retrieving the content page within the same iterative process. In certain embodiments, the user database may be searched either before or after the content page has been retrieved. This can be based upon a latency determination that is contingent upon the allocated bandwidth available over the network, and/or the lag between transmission times between the web server polling the user database and retrieving the content page from the network.

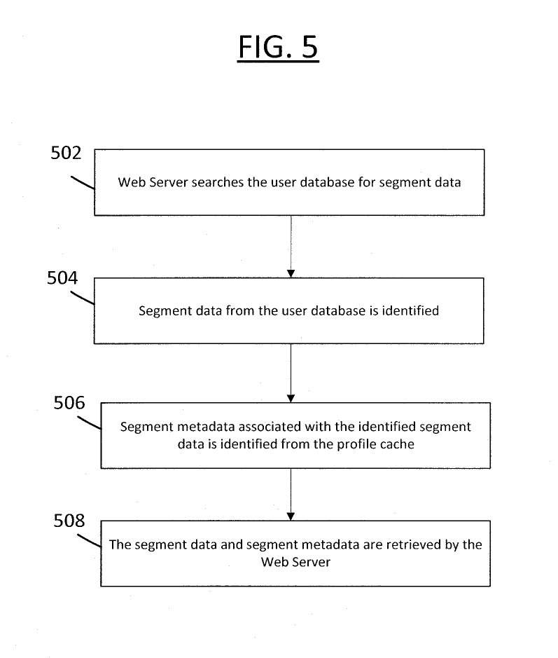

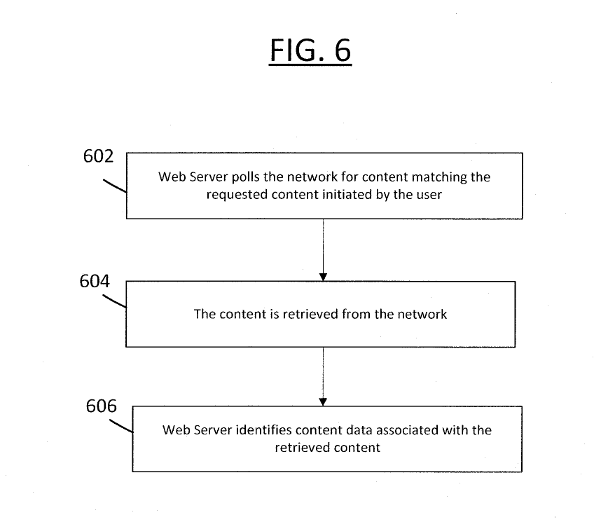

At Step 308, the collected segment information and content data are communicated to an advertisement server. The collection of the segment information and content data will be discussed in more detail in relation to FIGS. 5-6 below. The advertisement server polls an associated advertisement database, and selects an advertisement that correlates with the requested content and/or the user segment information. Step 310. The advertisement database contains advertisements and their associated metadata. The ad metadata includes information relating to the type of advertisement, size, dimension, and other display qualities including content within the advertisement. The ad metadata further includes information corresponding to demographics, geo-data, types of content and the like. The advertising server matches the provided segment information, specifically the segment metadata, against ad metadata, in addition to matching the information associated with the content page against the ad metadata. Upon a match between at least a portion of the segment information, content data and the ad metadata, the advertisement associated with the identified ad metadata is selected. Next, the selected advertisement is transmitted to the user device for rendering with the requested content. Step 312. In some embodiments, the content page and the advertisement can be combined for singular viewing on a page prior to delivery to the user, or it can be combined at the user computing device by the device or the web browser.

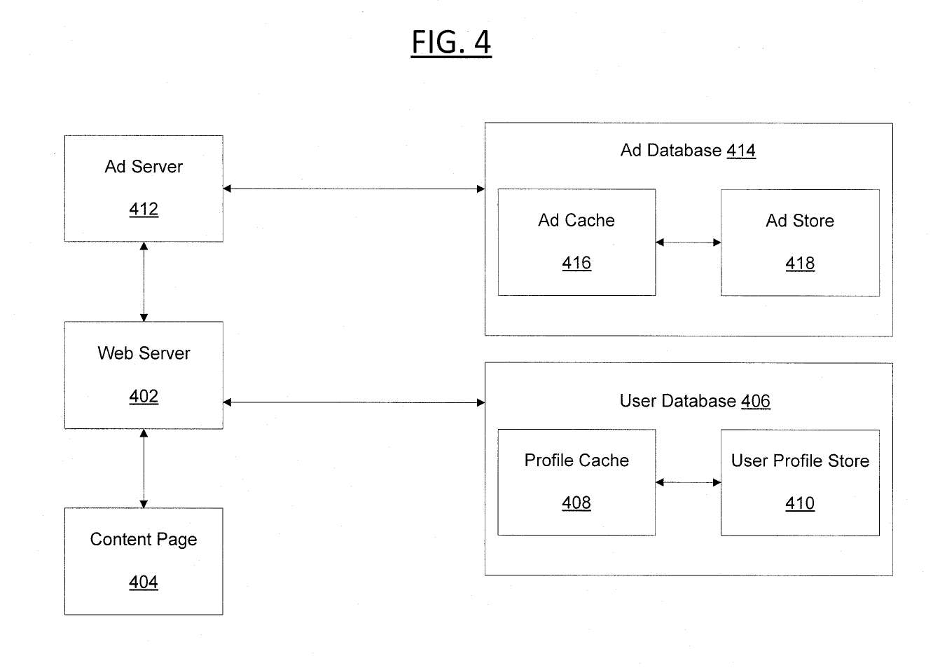

FIG. 4 is an exemplary system diagram illustrating the entities that the web server 402 interacts with in order to retrieve the content page and the user's segment information, and ultimately serve a contextually based advertisement. The web server 402 is in communication with an advertisement server 412 and a user database 406. The web server 402 performs a search for the content page 404, and searches the user database 406 for the user's segment information. As discussed below, segment information comprises segment data and associated segment metadata. The content page 404 is retrieved over the network. The retrieved content page 404 is contingent upon the user's request, as discussed in step 302 in FIG. 3. The retrieved content page 404 provides information identifying advertisement availability within the content page. The content page 404 dictates the positioning of potential advertisements placement and display within the page. The content page 404 further identifies the type of content, size, dimension, and other display qualities a potential advertisement may need in order to conform to the page.

The user database 406 provides the requesting web server 402 with a user's profile information, including segment information. As discussed above, segment information relates to a user's interests and/or activities. Also, as discussed above, the user segment information can be updated based upon the requested content (regarding the recency and frequency of access, which is discussed below in more detail).

The user database 406 comprises a profile cache 408 and a user profile store 410. According to some embodiments, the user profile store 410 stores a user's profile information, including a user's segment data. The profile cache 408 houses the metadata associated with the segment data. The profile cache 408 stores the metadata in order to expedite retrieval time and decrease latency. As discussed above, segment data represents categories of content (or information) related to media, e.g., images. That is, segment data can relate to particular content sets. For example, content sets can include media, e.g., images take from concert shows, travel, life events, and the like. The profile cache 408 stores the metadata for the segment data, thereby enabling fast and efficient access to the segment data. Additionally, the segment metadata can include metrics related to the content within the segment data. Such metrics can include information describing the recency and frequency a user renders specific types of segment data. Thus, segment data for a user can be ranked or weighted based upon the recency and frequency. Such ranking/weighting can be based upon metrics for specific types of segment data. For example, if a user frequently uploads (or views) pictures of vacations the user has taken, and less frequently views pictures of concerts the user has been to, the segment metadata stored in the profile cache can reflect this information. Thus, for the user, segments related to travel are ranked/weighted higher than those segments related to concerts. Therefore, in some embodiments, advertisements may be served solely (or additionally) in accordance with the highest ranked segment. This is discussed below in more detail. In some embodiments, serving of advertisements based solely on segment information can occur upon a user logging in to a site, since there typically is no page content at the login screen, for example. Serving advertisements based solely on segment information can also occur irrespective of content on a web page or web site. That is, advertisements can be based solely on the priority (or ranking) of the segment information upon a user viewing a photo-stream, uploading content, downloading content, signing out, and the like.

In a non-limiting example, a user has taken numerous pictures on a recent trip to New York of the MetLife Building. The segment data related to the picture stored in the profile store 410 relates to a location: e.g., the MetLife Building in New York, N.Y. The segment data can be represented by a name: MetLife Building, which also can be stored in the profile store 410. The corresponding location data stored in the profile cache 408 can provide the geographic information for such location. For example, for the MetLife Building, the address can be stored in the profile cache 408: 200 Park Avenue, New York, N.Y. The saved segment data within the user profile store 410 can either take a standard name, or a user can rename segment data in order to personalize such information. In some embodiments, the segment data in the above example can be categorized according to topic then sub-topic. For example, a picture of the MetLife Building in New York, N.Y. from a recent vacation can be categorized in a segment: vacation/New York/landmarks. Therefore, as discussed below, advertisements can be served based on segment data related to the picture according to vacations, the location New York, or landmarks in NY, or a combination of the three sub-segments.

As discussed above, segment data can be arranged according to a priority and/or proximity. Such arrangement (or ranking) can occur dynamically based upon the recency or frequency for which a user views specific content. In some embodiments, the arrangement can also be ordered by the user. Thus, ads may be selected according to top-ranked segment information. That is, ads can be matched and served based on segment information that has been identified as a top-priority to the user. Priority may be based upon recency, frequency and or other known or to be known metrics for determining a user's interest(s). These metrics or scores may be compiled into a score, which is saved as segment metadata (associated with particular segment data). Such scores may be used to reflect the types or contextual relevancy for which ads may be served to a user. For example, on Jan. 1, 2012 user A had uploaded some travel pictures he took while in San Francisco, Calif. Thus, at that time, assuming for simplicity and explanation purposes that user A was a new user with no other activity, a user profile was built for user A. The user profile contained segment information related to “travel” respective of the San Francisco photos. The segment information reflects a score of “travel:score_{—}1”. (Note, the score can be broken down to identify segment data and segment metadata: “travel” being the segment data, and “score_{—}1” being the segment metadata.) Thus, upon user A viewing content, the user may be served ads related to travel. However, more recently, on Dec. 1, 2012, user A now has uploaded pictures of his new born baby, categorized as “parenting”. The segment information must now be updated. Since the baby pictures were uploaded more recently, they can be delegated as higher priority, as reflected by a higher score: “parenting:score_{—}2, travel:score_{—}1”. Thus, the “parenting” segment ranks higher in priority compared to “travel,” which is based on recency and frequency of the respective events. (Note, in some embodiments, a segment's score may also be based upon the amount of pictures in an album or the activity respective an album. For example, if the baby pictures outnumbered the travel pictures, the higher number of baby pictures could factor into the priority ranking of segments. It should be understood that recency and frequency are not the only factors for determining priority of a segment, as other known and to be known metrics may be used in addition to, or in replace of such determinations.) Therefore, advertisements will be targeted with parenting ads, e.g., baby clothes, baby toys, and the like. Such targeting can occur on various sections of photo-sites where user A interacts, such as: login, photo-streaming, uploading, downloading, editing, sign-out, and the like. As a result, advertisements contingent upon a user's segment information would generate a higher click-through rate and higher revenue, as well as a better user experience that will increase engagement and time-on-site.

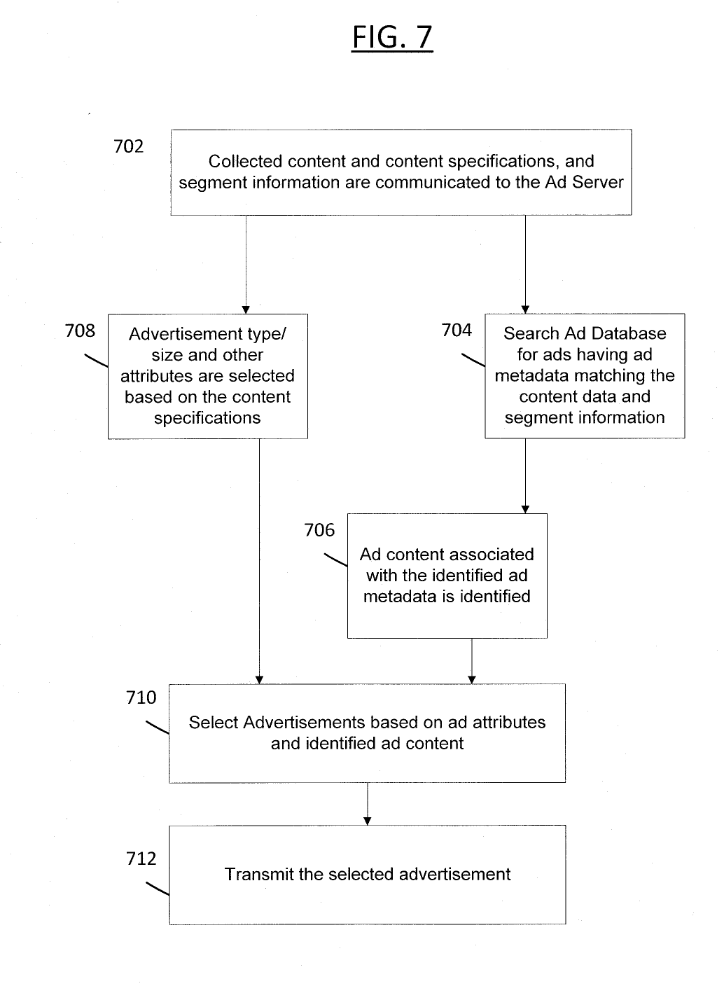

As discussed in more detail in relation to FIG. 7 below, the advertisement server 412 polls an associated advertisement database 414, and selects an advertisement that correlates with the information stored within the user database 406. The advertisement database 414 contains advertisements within an ad store 418 and their associated metadata in the ad cache 416. The ad metadata includes information relating to the type of advertisement, size, dimension, and other display qualities. The ad metadata further includes information corresponding to demographics, geo-data, types of content and the like. As discussed below, the advertising server 412 matches the provided content data and segment information (e.g., segment metadata) against ad metadata. That is, when the ad server 412 is presented with content data and segment metadata, the ad server 412 compiles the segment metadata in conjunction with the information being served on a currently rendered page, and determines if there is a match for an advertisement. Upon a determined match, the advertisement associated with the identified ad metadata is selected.

FIGS. 5-6 illustrate processes for retrieving segment information (which includes segment data and associated segment metadata) and content page information in accordance with the system discussed in FIG. 4. FIG. 5 provides the work flow of how the web server 402 retrieves segment data and associated segment metadata from the user database 406. In Step 502, the web server 402 requests segment data from the user database 406. First, segment data is retrieved from the user profile store 410. Step 504. As discussed below, the segment data is identified based upon the content data from the content page. That is, if the content data relates to content of an image related to sailing, the web server will identify (or search for) segment data in the user database related to sailing. Such identification can be based upon analysis of descriptive information associated with the content and the segment data (e.g., segment metadata). In some embodiments, if no match for sailing can be found, the web server may broaden the scope to include a topic for which sailing would be include, e.g., water sports. In some embodiments, the segment data will be identified based upon a user's priority listing with ranks the segment data according to recency and/or frequency of accessing content reflective of the segment data, as discussed above. In some embodiments, if there is no match between the content data and the segment data, the segment data retrieved is that of the top priority (or highest ranked segment data). With this information, the profile cache 408 is polled. The associated segment metadata in the profile cache 408 is then retrieved. Step 506. The retrieved segment metadata from the profile cache and segment data from the user profile store are then returned to the web server 402 as segment information. Step 508. In some embodiments, the order of how information relating to the segment data is retrieved can be switched. For example, the segment metadata from the profile cache 408 can be retrieved first, and used to identify specific segment data from the user profile store 410.

FIG. 6 illustrates an embodiment of how the content page 404 is retrieved. Based upon the request received from the user computing device 110 (from FIG. 1), the web server polls the network 144, and in some instances remote locations within the network 144, for the requested content page 404. Step 602. As discussed above, the content page 404 can be a photo-sharing site, or a particular web page displaying a photo within such site, e.g., Flickr®. After the content page 404 has been retrieved, in Step 604, the content page 404 is then analyzed for content data. Step 606. The content data comprises information describing the content, including content (or page) attributes. The content data include descriptions and dimensions of the page and content, and information related to the content displayed on the content page 404. For example, content data can include, but is not limited to, descriptions, types and formats for images (or sound, video), and ancillary metadata (or tags) associated with the content. Such metadata can include, but is not limited to, digital data including format, data and time information, description information, source information, copyright information, geo-location information, compression data, security information, and the like. Thus, the page attributes can be compared against the segment information (segment data and metadata), as discussed above. The page attributes can also provide a directive as to how any and all potential advertisements will be displayed. The page attributes identify advertisement availability within the content page, and describe where potential advertisements can be displayed within the content page 404. The content page 404 page attributes can further identify the type size, dimension, and other display qualities a potential advertisement must have to fit within the page. According to some embodiments, if a content page 404 has more than one available advertising spot available on the page, the user can denote whether the secondary ads filling the additional spots should relate to the top priority segment data, subsequent segment data stored in the user database 406, or other segment data or context related data associated with the content currently being displayed on the content page 404.

Turning back to FIG. 4, in relation to the discussion related FIGS. 5-6, the web server 402 retrieves the content page 404 and information relating to segment data. After the content page 404 information and the segment information from the user database 406 have been collected, the content page 404 information and the segment information are communicated back to the requesting web server 402. The web server 402 communicates or shares this information with the advertisement server 412 and an advertisement database 414. As illustrated in FIG. 4, the advertisement database 414, which can be associated with or housed within the advertisement server 412, comprises an advertisement cache 416 and an advertisement store 418. As discussed below in relation to FIG. 7, the advertisement cache 416 houses the ad metadata and the advertisement store 418 houses the advertisements which are associated with the ad metadata, respectively.

In connection with the discussion above to FIGS. 3-6, FIG. 7 depicts a work flow of the web server 402 communicating the collected content data and segment information to the advertisement server 412, and how the information is utilized for selecting a relevant advertisement for the user based in part on the content displayed on a content page 404. In Step 702, the collected content data from the content page 404 (from item 606 in FIG. 6) and segment information (from item 508 in FIG. 5) are communicated (or shared) from the web server 402 to the advertisement server 412. As discussed above, the segment information includes a user's segment data and associated segment metadata. The segment data being selected from a prioritized listing of categorized content. As discussed above, the categorized content is organized according to the user's expressed interested and activities, and is ordered according to the type of content the user has historically (or currently depending on frequency and recency) interacted with the most (e.g., rendered, viewed, uploaded, downloaded). Upon receipt of the content data and segment information, the advertisement server 412 performs a search for a relevant advertisement within the advertisement database 414. The search for an advertisement is based at least on the content data (which includes information contained with and associated with the content page 404) and segment information.

In Step 704, the advertisement server 412 searches the advertisement database 414 for advertisements that match the content data and segment information. The advertisements and advertisement content are searched in connection with the ad metadata. The ad metadata comprises content information which is correlated with specific types or categories of content and content attributes, and provides specific sensitivity to particular types/categories of content. Thus, advertisements are matched to the content data and segment information based on the content information comprised within the ad metadata. When the advertisement server 412 receives the content data and segment information, the ad server 412 compares the content data and segment metadata against the ad metadata, and determines if there is a match. Upon a match being identified between the content data and segment metadata with the ad metadata associated with an advertisement, the advertisement corresponding to the matching ad metadata is identified. Step 706. Thus, in some preferred embodiments, Step 706 entails advertisement content being identified, as the advertisement that will be served to the user is selected based at least upon the ad content and other attributes, as discussed in Step 708. If no advertisements match, the ad-serving engine can provide the nearest relevant advertisement possible to the content data related to the content page 404. In some embodiments, if no advertisements match, the nearest relevant advertisement possible to the segment data will be matched.

In some preferred embodiments, Step 706 includes weighing the content data from the content page 404 against the segment data. Such weighing occurs when there is a lack of conformity between the information respective of the content data and segment data. That is, the content data and segment data do not correlate to the same type of content. This may occur if the content data and segment data relate to a similar context, e.g., sport, but differing sports, e.g., basketball vs. baseball. Upon this occurrence, the content data and segment data can be compared against one another based upon the segment information in the user's user profile. Should the content data correlate with content identified in segment data at the highest priority, then the content data and segment data match; therefore there is conformity between the two. However, if there is no conformity, in some embodiments, the segment data will override the content data, as the segment data is derived directly respective of the user's interests. That is, the segment data is compiled based on activities and interests of the user, and indicates types of content and categories of content the user is interested in, in a prioritized listing. Therefore, if the content data does not at least match a portion of the content represented by the segment data selected from the prioritized listing, or meets below a predefined threshold, the segment data will be used to select an advertisement. Such threshold can be set by the system, content provider (e.g., Flickr), user, or some combination thereof, and can be adjusted accordingly by any party either manually or dynamically.

By way of another non-limiting example, a user's activities can lend towards advertisers being able to target the user. For example, based on a user's activities and interests, multiple segments can be associated with the user. Such segments can be, for example, travel, recreation, animals. As discussed above, there are scores associated with these segments, therefore, according to the current listing of segments, and based on the user's interests, travel has scored higher than recreation, and recreation higher than animals. That is, the user has expressed interests in, highest priority followed by lowest, travel, then recreation, then animals. As discussed above, such interest can be determined based on the user's recency and/or frequency related to the user rendering (or viewing) similar content respective of the segment. Upon the user viewing a photo of his friend's vacation hiking, the following analysis can occur. The photo carries two contexts: travel and recreation. The user has segments for travel and recreation, however, travel is of higher priority to the user. Therefore, ads can be served based on travel. Additionally, in some embodiments, the context of the photo may not serve any relation to the service of the ads. For example, if the context of the photo the user is viewing is related to cooking, the user can be served advertisements related solely to his categorized priority listing: travel, recreation, animals. Thus, since the travel category is ranked the highest within his segment information, the user can be served advertisements related to travel (e.g., airfare, train discounts, ferry rides, and the like), even though the photo being viewed is related to cooking Additionally, advertisements served on subsequent pages traversed by the user on the photo-sharing site (or within the same network) may also be solely related to his segment information. In some embodiments, the ads may cycle through the user's priority listing in order to capture the user's attention at each page, and in some embodiments, the ads may remain related to the user's top ranked segment information. In some embodiments, the user may control how the ads are selected by denoting which segment information to utilize, and this may be performed periodically, per site, or according to a user (or system) set schedule.

In some embodiments, certain categories of advertisements are more expensive and/or are more in tune with public interest. That is, certain categories of advertisements are in higher demand, or are related to content which is more expensive. Additionally, certain advertisements, such as motion graphics, are more expensive to serve then plain text or images. Therefore, the ad-serving engine discussed herein can compare the cost of serving ads related to the content data and segment information, and the ads related to the content (respective of the content data and segment data) having the lower (or higher) cost will be utilized in selecting the advertisement. In some embodiments, regarding the cost of serving an ad, such comparisons may take place only if there is no conformity, or conformity below a threshold, between at least a portion of the content data and segment information. However, embodiments exist where the content data will be matched despite no conformity due to the user's expressed interest in visiting the page and viewing the content. Alternatively, embodiments exist where the segment data will be matched despite no conformity with the content data due to the user's expressed interests derived from his/her user profile information (and segment priority listing).

By way of a non-limiting example, the content data from content page relates to an image of a sunrise. The segment data retrieved from the user profile of a user relates to a sunset. It is determined, based on the ranked priority within the user's profile that segment data related to sunsets ranks higher than segment data for sunrise; therefore, the segment data overrides the content data, and ad metadata related to a sunset is matched to the segment data.

In another non-limiting example, in accordance with the above example, it is determined by the ad-serving engine that advertisements for sunsets are more expensive to serve than those of a sunrise. Therefore, in some embodiments, the ad metadata related to a sunset will be identified based on the content data (related to the sunrise), which can be in accordance with an overall cost analysis and/or current public demand or overall market environments (e.g., seasons, market fluctuations, sales and the like).

In Step 708, the content data of the content page 404 can also be utilized to determine the specifications of the advertisement that will be served to the user. The specifications of the advertisement may have to conform to the specifics dictated by the content page. As discussed above, the content page provides information identifying advertisement availability within the content page. The content page dictates the positioning within the page where potential advertisements can be displayed. The content page can further identify the type size, dimension, and other display qualities a potential advertisement may have to conform to in order to be properly displayed. According to some embodiments, the advertisement server 412 can determine the specifications of the advertisement (in Step 708) and identify advertisement content (Steps 704-706) in the same iterative process. In certain embodiments, Step 708 may be performed either before, during, after, or any combination of the three in relation to Steps 704-706.

In Step 710, an advertisement is selected (or retrieved) based on the results of Steps 706 and 708. In some embodiments, the advertisement can be selected based upon the result of Step 706, and modified to conform to the results of Step 708. In some embodiments, as in Step 712, the selected advertisement is shared or communicated with the web server. In some alternative embodiments, the selected advertisement is sent directly to the user's computing device. In the embodiments where the advertisement is sent to the web server, the web server can compile the information from the content page and the advertisement, and send a fully built web page containing the selected advertisement to the user's computing device. In the embodiments where the selected advertisement is sent directly to the user's computing device, the web browser that initiated the request receives the content page and advertisement separately, and in real-time compiles and presents the web page equipped with the advertisement for viewing by the user. Alternative embodiments also exist where the content page and advertisement are sent to the web server and compiled into one built page by the web browser.

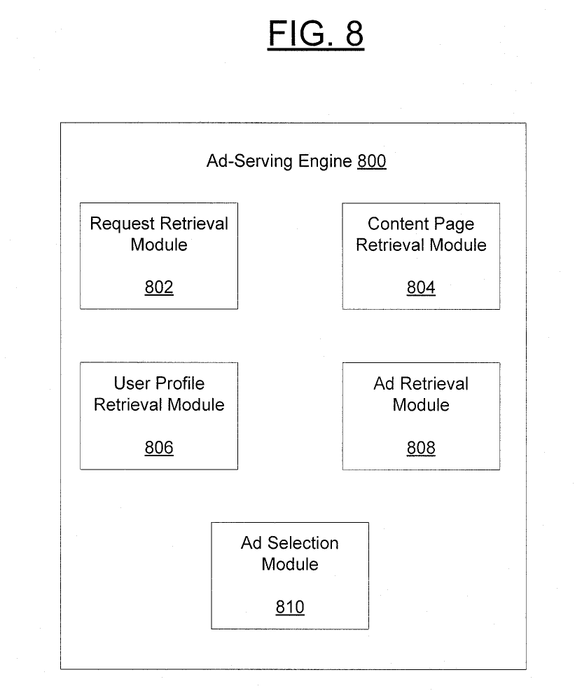

FIG. 8 illustrates an embodiment of an ad-serving engine performing the systems and methods discussed herein. In some embodiments, the ad-serving engine 800 could be hosted by the user computing device 110 of FIG. 1. In another embodiment, the ad-serving engine 800 could be hosted by the web server of FIGS. 1 and 4. In yet another embodiment, the ad-serving engine 800 could be hosted by the advertising server of FIGS. 1 and 4.

The ad-serving engine 800 comprises a request retrieval module 802, content page retrieval module 804, user profile retrieval module 806, ad retrieval module 808 and an ad selection module 810. The request retrieval module 802 is configured to receive a user request for a content page. As discussed above, the request can be generated by the user viewing a web page within a photo sharing site, or searching for a content page via a web browser. The content page retrieval module 804 is configured to perform a search for the requested content page. The user profile retrieval module 806 polls a user database for the user's profile information, including segment data and segment metadata, as discussed above.

The ad retrieval module 808 is configured to receive the collected information relating to the segment information and the content page. The ad selection module 810 is configured to search for and select at least one advertisement that correlates with the user's segment data and metadata, and content data from the content page. In some embodiments, the ad selection module 810 is also configured to select advertisements based upon specifics defined by the retrieved content page, as discussed above. After the advertisement has been selected by the ad selection module 810, the ad serving engine 800 is configured for facilitating presentation of the selected advertisement with the retrieved content page to the user computing device 110.

In accordance with some embodiments, the above disclosure will be illustrated via a non-limiting example in order to showcase the applicability of the systems and methods discussed herein. In one non-limiting example, a Yahoo! user, Male, from the Asia-Pacific is looking at images of San Diego, Calif. beach. These images were uploaded by his friends to their respective Flickr® accounts. (It should also be understood that these images can be viewed from category browsing or from a search session, however these are non-exhaustive examples). As discussed above, there are business opportunities (or advertising availabilities) present within the scope of the user's browsing. For example, the user might travel to this destination in the future, and showing ads specific to San Diego, or locations within a certain proximity, can be of interest to the user and result in the user following an advertisement. Additionally, advertisements can be served related to the user's current locations, respective of beach property. For example, ads for beaches and lodging in Thailand or Goa beach may be displayed, as their respective context are similar to the San Diego, Calif. beach context, but are more geo-located to the user. Additionally, it should be appreciated that target concepts can be applied, such as, airlines, hotels, recreation agencies, and the like. As a result, advertisers will have a better reach to target users, which can increase advertising metrics associated with views, revenue, CTR, purchases and the like. Additionally, advertising in the manner discussed herein enables a more personalized experience for the user than just simple demographic and geo-based targeting.

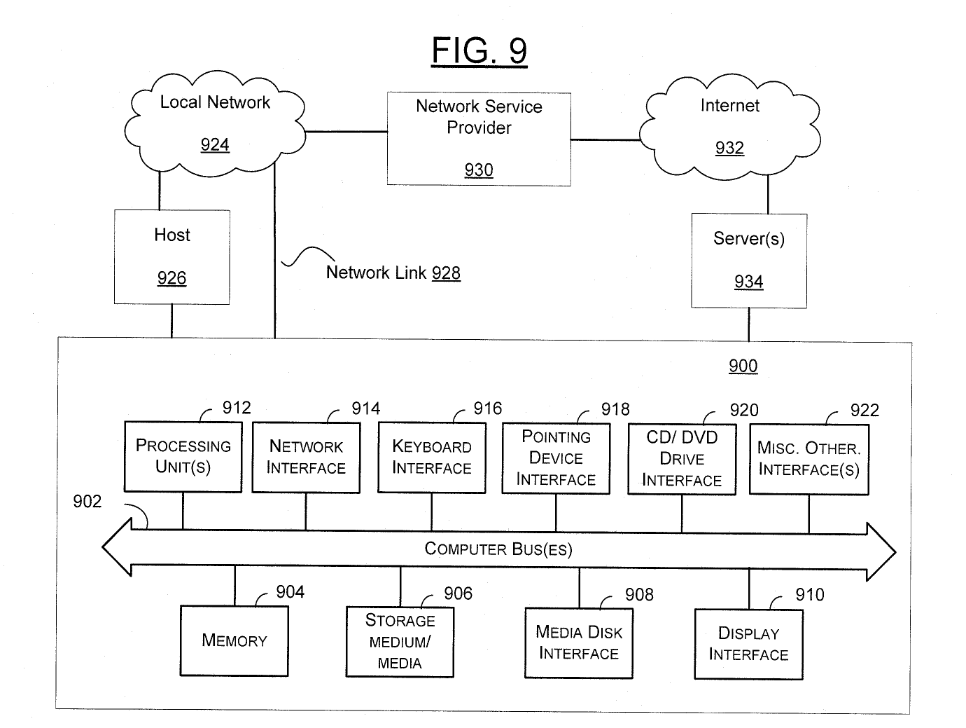

As shown in FIG. 9, internal architecture 900 includes one or more processing units, processors, or processing cores, (also referred to herein as CPUs) 912, which interface with at least one computer bus 902. Also interfacing with computer bus 902 are computer-readable medium, or media, 906, network interface 914, memory 904, e.g., random access memory (RAM), run-time transient memory, read only memory (ROM), media disk drive interface 920 as an interface for a drive that can read and/or write to media including removable media such as floppy, CD-ROM, DVD, media, display interface 910 as interface for a monitor or other display device, keyboard interface 916 as interface for a keyboard, pointing device interface 918 as an interface for a mouse or other pointing device, and miscellaneous other interfaces not shown individually, such as parallel and serial port interfaces and a universal serial bus (USB) interface.

Memory 904 interfaces with computer bus 902 so as to provide information stored in memory 904 to CPU 912 during execution of software programs such as an operating system, application programs, device drivers, and software modules that comprise program code, and/or computer executable process steps, incorporating functionality described herein, e.g., one or more of process flows described herein. CPU 912 first loads computer executable process steps from storage, e.g., memory 904, computer readable storage medium/media 906, removable media drive, and/or other storage device. CPU 912 can then execute the stored process steps in order to execute the loaded computer-executable process steps. Stored data, e.g., data stored by a storage device, can be accessed by CPU 912 during the execution of computer-executable process steps.

Persistent storage, e.g., medium/media 906, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 928 typically provides information communication using transmission media through one or more networks to other devices that use or process the information. For example, network link 928 may provide a connection through local network 924 to a host computer 926 or to equipment operated by a Network or Internet Service Provider (ISP) 930. ISP equipment in turn provides data communication services through the public, worldwide packet-switching communication network of networks now commonly referred to as the Internet 932.

A computer called a server host 934 connected to the Internet 932 hosts a process that provides a service in response to information received over the Internet 932. For example, server host 934 hosts a process that provides information representing video data for presentation at display 910. It is contemplated that the components of system 900 can be deployed in various configurations within other computer systems, e.g., host and server.

At least some embodiments of the present disclosure are related to the use of computer system 900 for implementing some or all of the techniques described herein. According to one embodiment, those techniques are performed by computer system 900 in response to processing unit 912 executing one or more sequences of one or more processor instructions contained in memory 904. Such instructions, also called computer instructions, software and program code, may be read into memory 904 from another computer-readable medium 906 such as storage device or network link. Execution of the sequences of instructions contained in memory 904 causes processing unit 912 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 900. Computer system 900 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 902 as it is received, or may be stored in memory 904 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, at a computing device over a network, a request from a user for a photo on a page of a photo-sharing website;
identifying, via the computing device, descriptive information related to said photo;
searching, via the computing device, a user profile associated with the user for segment information comprising segment data and segment metadata, said segment data comprising a prioritized listing of content categories representative of a level of interest the user has for each content category, said segment metadata comprising descriptive information related to each category, said searching comprising identifying a specific content category among the segment data based on the descriptive information of the photo;
searching, via the computing device, an advertisement database to identify an advertisement based on the identified content category; and
facilitating serving, via the computing device, said advertisement with said photo on the page to the user over the network.

2. The method of claim 1, further comprising:
identifying the specific content category based solely upon the prioritized listing of content categories, wherein the specific content category is ranked the highest within said listing.

3. The method of claim 1, further comprising:
identifying advertisement metadata stored in the advertisement database associated with the advertisement based upon the segment metadata associated with the identified content category, said advertisement metadata comprising descriptive information related to the advertisement; and
selecting the advertisement based on the identified advertisement metadata.

4. The method of claim 3, wherein the descriptive information of the advertisement metadata comprises content information of the advertisement and attributes of the advertisement.

5. The method of claim 1, further comprising:
searching the advertisement database to identify the advertisement based on the identified content category and requested photo, said searching comprising identifying advertisement metadata associated with the advertisement based on the descriptive information related to said photo and the segment metadata associated with the identified content category; and
selecting the advertisement based on the identified advertisement metadata.

6. The method of claim 5, further comprising:
determining, based on the descriptive information of the photo, a content category within said listing said photo relates to;
comparing the determined content category for the photo and the identified content category; and
selecting the advertisement based on said comparison.

7. The method of claim 6, wherein if at least a portion of the determined content category for the photo and the identified content category match at or above a threshold, said advertisement is selected based on both the descriptive information of the photo and the identified content category.

8. The method of claim 6, wherein if the determined content category for the photo and the identified content category do not match, or match below a threshold, said advertisement is selected based on the identified content category.

9. The method of claim 6, wherein if the determined content category for the photo and the identified content category do not match, or match below a threshold, said advertisement is selected based on the photo.

10. The method of claim 1, further comprising:
determining a cost for serving the advertisement based on the photo;
determining a cost for serving the advertisement based on the identified content category; and
selecting an advertisement in accordance with a lowest determined cost.

11. The method of claim 1, wherein the priority listing of content categories is based upon metrics derived from the user's online activity, said metrics are utilized to determine the priority of content categories, wherein a content category with a higher respective metric from that of another content category is of higher priority within said listing.

12. A non-transitory computer-readable storage medium tangibly encoded with computer executable instructions, which when executed by at least one processor of a computing device, perform a method comprising:
receiving, over a network, a request from a user for a photo on a page of a photo-sharing website;
identifying descriptive information related to said photo;
searching a user profile associated with the user for segment information comprising segment data and segment metadata, said segment data comprising a prioritized listing of content categories representative of a level of interest the user has for each content category, said segment metadata comprising descriptive information related to each category, said searching comprising identifying a specific content category among the segment data based on the descriptive information of the photo;
searching an advertisement database to identify an advertisement based on the identified content category; and
facilitating serving said advertisement with said photo on the page to the user over the network.

13. The non-transitory computer-readable storage medium of claim 12, further comprising:
identifying the specific content category based solely upon the prioritized listing of content categories, wherein the specific content category is ranked the highest within said listing.

14. The non-transitory computer-readable storage medium of claim 12, further comprising:
identifying advertisement metadata stored in the advertisement database associated with the advertisement based upon the segment metadata associated with the identified content category, said advertisement metadata comprising descriptive information related to the advertisement; and
selecting the advertisement based on the identified advertisement metadata.

15. The non-transitory computer-readable storage medium of claim 12, further comprising:
searching the advertisement database to identify the advertisement based on the identified content category and requested photo, said searching comprising identifying advertisement metadata associated with the advertisement based on the descriptive information related to said photo and the segment metadata associated with the identified content category; and
selecting the advertisement based on the identified advertisement metadata.

16. The non-transitory computer-readable storage medium of claim 15, further comprising:
determining, based on the descriptive information of the photo, a content category within said listing said photo relates to;
comparing the determined content category for the photo and the identified content category; and
selecting the advertisement based on said comparison.

17. The non-transitory computer-readable storage medium of claim 16, wherein if at least a portion of the determined content category for the photo and the identified content category match at or above a threshold, said advertisement is selected based on both the descriptive information of the photo and the identified content category, wherein if the determined content category for the photo and the identified content category do not match, or match below a threshold, said advertisement is selected based on the identified content category.

18. The non-transitory computer-readable storage medium of claim 17, wherein if the determined content category for the photo and the identified content category do not match, or match below a threshold, said advertisement is selected based on the photo.

19. A system comprising:
at least one computing device comprising:
memory storing computer-executable instructions; and
one or more processors for executing said computer-executable instructions, comprising:
receiving, over a network, a request from a user for a photo on a page of a photo-sharing website;
identifying descriptive information related to said photo;
searching a user profile associated with the user for segment information comprising segment data and segment metadata, said segment data comprising a prioritized listing of content categories representative of a level of interest the user has for each content category, said segment metadata comprising descriptive information related to each category, said searching comprising identifying a specific content category among the segment data based on the descriptive information of the photo;
searching an advertisement database to identify an advertisement based on the identified content category; and
facilitating serving said advertisement with said photo on the page to the user over the network.

20. The system of claim 19, further comprising:
identifying the specific content category based solely upon the prioritized listing of content categories, wherein the specific content category is ranked the highest within said listing.
